(19) United States
(12) Patent Application Publication
(10) Pub. No.: US 2014/0075015 A1
(43) Pub. Date: Mar. 13, 2014

(54) METHODS AND SYSTEMS FOR MONITORING AND CONTROLLING ELECTRONIC DEVICES

(71) Applicant: TRITON SYSTEMS, INC., Chelmsford, MA (US)

(72) Inventors: Johnny Yat Ming CHAN, Irwindale, CA (US); Stephen Anthony TUNNELL, Oceanside, CA (US)

(73) Assignee: TRITON SYSTEMS, INC., Chelmsford, MA (US)

(21) Appl. No.: 13/831,243

(22) Filed: Mar. 14, 2013

Related U.S. Application Data
(60) Provisional application No. 61/700,838, filed on Sep. 13, 2012.

(51) Int. Cl. H04L 12/24

(52) U.S. Cl. CPC H04L 41/14
USPC 709/224

(57) ABSTRACT

Methods and systems for managing a device are described. A device agent may receive device information associated with a device, such as information concerning operation of the device. The device agent may be configured to maintain a device model or operating protocol associated with the operation of the device, such as various operational parameters, operating characteristics and/or programs. The device agent may monitor the device based on the device information streamed, for example, in substantially real time from the device. A central management system may be in communication with the device agent and may operate to verify and/or update the device model based on the device information. The device information may be presented to client devices, for instance, through a graphical user interface. The client devices may also be able to transmit control signals to the central management system for controlling various aspects of the device.

### CROSS-REFERENCE TO RELATED APPLICATIONS

This application claims priority to U.S. Provisional Application No. 61/700,838, entitled, “Synchronous Medical Monitoring and Control System,” filed Sep. 13, 2012, which is incorporated herein by reference in its entirety.

### GOVERNMENT INTERESTS

Not Applicable

### PARTIES TO A JOINT RESEARCH AGREEMENT

Not Applicable

### INCORPORATION BY REFERENCE OF MATERIAL SUBMITTED ON A COMPACT DISC

Not Applicable

### BACKGROUND

Many electronic devices and pieces of equipment include elements capable of providing information related to the operating conditions of the device or piece of equipment. However, these elements generally use different communication protocols and provide information in varying formats. As such, it is challenging to obtain a clear, unified picture of the information available from the device, let alone from more than one device at a time. For example, a patient in a healthcare facility may be receiving treatment and/or being monitored through multiple, heterogeneous devices, such as an intravenous (IV) system, a heart monitor, and a ventilator. Currently, a healthcare professional would have to separately monitor and control each device from within the patient room. As such, although access to device information is available, conventional technology does not provide an efficient method for monitoring or controlling devices from a centralized location.

### SUMMARY OF THE INVENTION

The invention described in this document is not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a device management system may comprise at least one management computing device comprising a processor, and a non-transitory, computer-readable storage medium in operable communication with the processor, wherein the computer-readable storage medium contains one or more programming instructions that, when executed, cause the processor to receive device information from at least one device, update a device model associated with the at least one device based on the device information, and update a local device model associated with the at least one device stored on at least one device agent operatively coupled to the at least one device, the at least one device agent being configured to receive device information from the at least one device and to monitor the device information based on the local device model.

In an embodiment, a method of managing at least one device may comprise providing at least one management computing device; receiving, by a processor of the at least one management computing device, device information from at least one device; generating, by the processor, a local device model update associated with the at least one device based on the device information; and updating, by the processor, a local device model associated with the at least one device stored on at least one device agent operatively coupled to the at least one device based on the device information, the at least one device agent being configured to receive device information from the at least one device and to monitor the device information based on the local device model.

In an embodiment, a device management system may comprise at least one device agent operatively coupled to at least one device, the at least one device agent being configured to receive device information from the at least one device; monitor the device information based on a local device model associated with the at least one device; and receive a local device model update from at least one management computing device operatively coupled to the at least one device agent, the at least one management computing device being configured to receive device information from the at least one device and to generate the local device model update based on the device information

### DESCRIPTION OF DRAWINGS

FIG. 1 depicts an illustrative device monitoring and control system according to some embodiments.

FIG. 2 depicts an illustrative control system according to an embodiment.

FIG. 3 depicts illustrative information and control signal flow according to some embodiments.

FIG. 4 depicts a first device information flow diagram for the acute care ventilation monitoring and control system according to an embodiment.

FIG. 5 depicts a second device information flow diagram for the acute care ventilation monitoring and control system according to an embodiment.

FIG. 6 depicts an illustrative data transmission flow diagram for the acute care ventilation monitoring and control system according to an embodiment.

FIG. 7 depicts an illustrative data presentation flow diagram for the acute care ventilation monitoring and control system according to an embodiment.

FIG. 8 depicts a first illustrative data and control information flow diagram for the acute care ventilation monitoring and control system according to an embodiment.

FIG. 9 depicts a second illustrative data and control information flow diagram for the acute care ventilation monitoring and control system according to an embodiment.

FIG. 10 depicts an illustrative control system network according to an embodiment.

FIG. 11 depicts a block diagram of exemplary internal hardware that may be used to contain or implement program instructions according to an embodiment.

### DETAILED DESCRIPTION

The terminology used in the description is for the purpose of describing the particular versions or embodiments only, and is not intended to limit the scope.

The present disclosure is directed toward a system configured to monitor information associated with electronic devices and to control the electronic devices based on the information. In an embodiment, an electronic device may be associated with a device agent configured to receive information from the electronic device and/or to control various aspects of the electronic device. The device agent may be configured to maintain a device model (or operating protocol) associated with the operation of the device, such as various operational parameters, operating characteristics and/or programs. In an embodiment, the device agent may be configured to provide local control of the device based on the device model and the device information. The device agent may be operatively coupled with a central management system positioned remotely from the electronic device and configured to receive the device information from the device agent. The central management system may be configured to provide central control of the device instead of and/or in addition to the local control provided by the device agent. In an embodiment, an operator may access the device information and/or control various aspects of the device through the central management system. For instance, the central management system may be configured to provide a client application accessible by client computing devices.

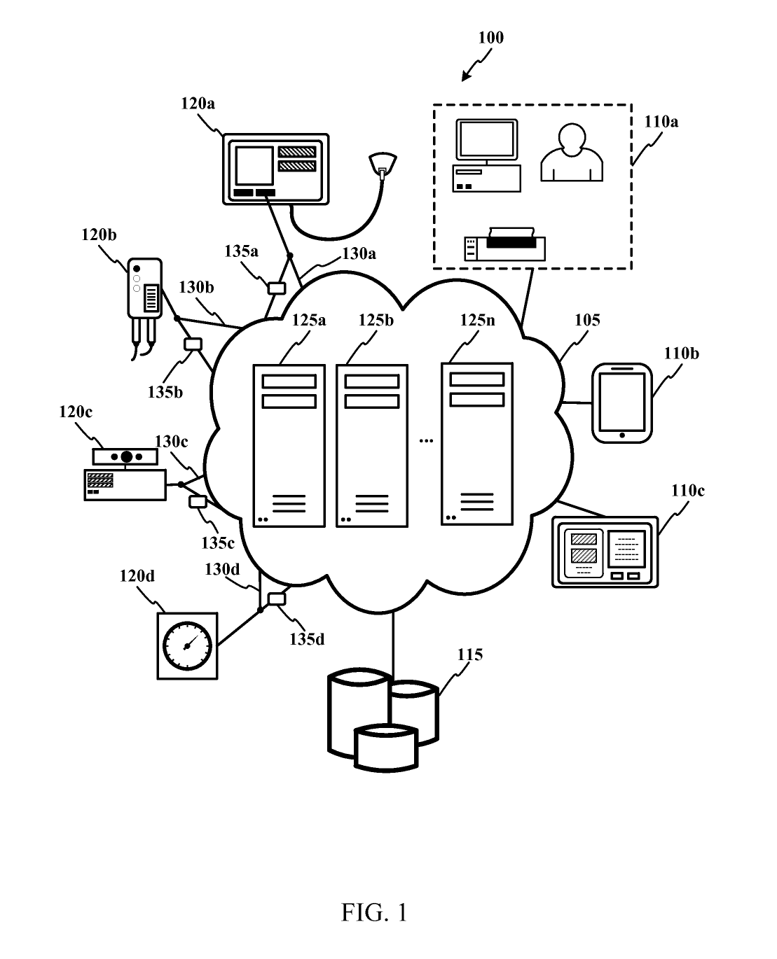

FIG. 1 depicts an illustrative device monitoring and control system according to some embodiments. As shown in FIG. 1, a device monitoring and control system 100 (“control system”) may include a network 105 of management computing devices 125a-125n. The management computing devices 125a-125n may include various types of computing devices, including, without limitation, a server, personal computer (PC), tablet computer, computing appliance, or smart phone device. Some of the management computing devices 125a-125n may be configured to operate a monitoring and control application (“control application”) configured to monitor and/or control various devices 120a-120d operably coupled to the network 105. The devices 120a-120d may include any type of electronic device capable of generating information and/or being controlled by the control application. For instance, the devices 120a-120d may include, without limitation, medical devices such as a ventilator 120a, automatic fluid injector 120b (for example, automated infusion device), a motion sensing system 120c (for example, a camera-based motion sensing system), or various sensors 120d (for example, pressure sensors, temperature sensors, or the like). The devices 120a-120d may be connected to the network 105 through a direct connection 130a-130d, such as an Ethernet connection or any other network connection. The devices 120a-120d may also be connected to a device agent 135a-135d that is connected to the network 105. In this manner, the control system 100 may interface directly with the devices 120a-120d through the direct connections 130a-130d and/or indirectly with the devices through the device agents 135a-135b.

According to some embodiments, the control system 100 may be configured to implement communication using various communication protocols, including, without limitation, Ethernet, wireless Ethernet, WiMax, cellular data network protocols (for example, third generation (3G) wireless technology, fourth generation (4G) wireless technology, including long-term evolution (LTE) technology), real-time transport protocol, real-time transport control protocol, transport control protocol/Internet protocol (TCP/IP), or the like.

The control application may be configured to transmit the device information to a database 115 or other data storage system. In an embodiment, the device information may also be used by the control application to monitor the operation of the devices 120a-120d. For instance, the control application may include a device program or protocol specific for each device 120a-120d and/or class of devices. In an example, the device 120a may include a ventilator, and the control application may include a device program configured to monitor the operational aspects of the ventilator, such as gas volume and number of breaths per minute. In another example, the device may include a pressure sensor 120d for a fluid supply system and a device program may be configured to generate an alarm event if the pressure is outside of a predetermined range. The device programs may also be configured to control the devices 120a-120d. For example, the device program for the ventilator device 120a may be configured to modify operational parameters of the ventilator device based on, for example, and without limitation, patient information entered by a remote operator 110a. In another example, the device program for the pressure sensor device 120d may be configured to close a valve, such as an electronically controlled servo-valve, when the pressure sensor device indicates that the pressure is outside of the predetermined range.

In an embodiment, the databases 115 may be configured to store data from other sources, such as third-party databases and/or information from third-party sources. For example, the databases 115 may include healthcare information, personal information, demographic information, and any other type of information capable of being used according to some embodiments described herein. The information may be used, among other things, when generating a device model.

The device agents 135a-135d may be configured to receive device information from the devices 120a-120d and to operate local control programs. According to some embodiments, the device agents 135a-135d may be located proximate to the devices 120a-120d. For example, a device agent 135a-135d may be implemented at least partially in software, and may be executed on a device 120a-120d. In another example, a device agent 135a-135d may be configured as a computing device located in the same room or same building as a device 120a-120d. In this manner, the device agents 135a-135d may operate as local monitoring and control components for the devices 120a-120d, and the management computing devices 125a-125n may operate as remote, centralized monitoring and control components for the devices 120a-120d. For example, the device agents 135a-135d may be configured to take over control (if they are not already in control) of devices 120a-120d if communication between is lost between the devices 120a-120d and the management computing devices 125a-125n.

Although the management computing devices 125a-125n may operate in a centralized manner, the management computing devices are not required to be in a centralized location, network, or the like. Embodiments may be configured such that the management computing devices 125a-125n are in separate locations, networks (physical and logical), and/or distributed computing environments.

The control system 100 may be operatively coupled to various client systems 110a-110c configured to receive device information and/or to control various aspects of the devices 120a-120d. For example, a client system may include an operator, manufacturer, or support provider 110a associated with the device, a client computing device 110b operating a client control application, a web-based application 110c operating on a remote computing device, or the like. The client systems 110a-110c may have various levels of access to the devices 120a-120d and the device information. For example, a client system 110a-110c may be configured to view device data and to perform certain reporting functions, such as a medical imaging control room capable of viewing images from a medical imaging device. In another example, a client system 110a-110c may be configured to view device data and control various aspects of a device 120a-120d. For example, an operator may stop a conveyer belt device responsive to viewing device information indicating an alarm condition on a client computing device 110b.

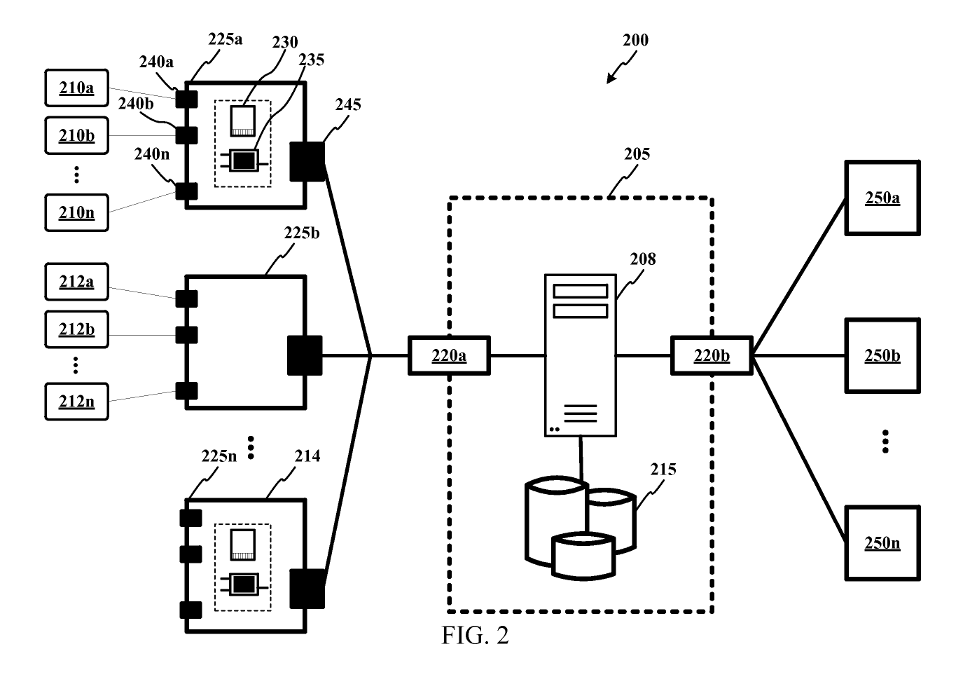

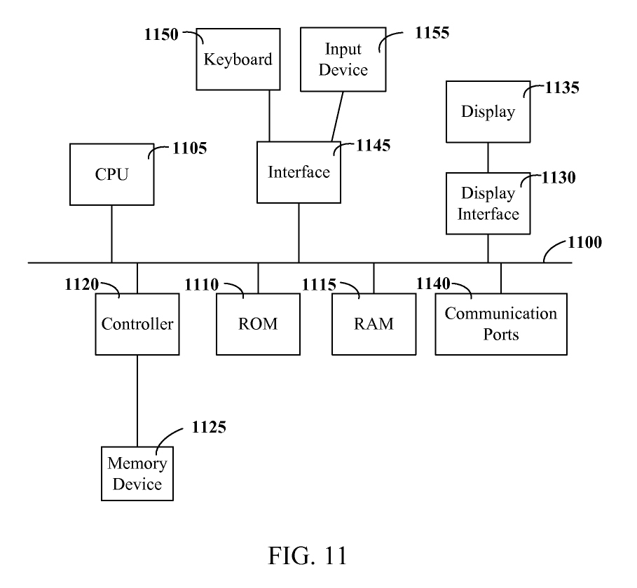

FIG. 2 depicts an illustrative control system according to an embodiment. As shown in FIG. 2, a control system 200 may include a central management system 205 having a management computing device 208. The management computing device 208 (or devices) may generally include one or more processors (not shown) and a non-transitory memory (not shown) or other storage device for storing programming instructions, one or more software programs (e.g., the control application), data or information regarding one or more applications, and other hardware, which may be the same or similar to a configuration as shown in FIG. 11 having a central processing unit (CPU) 1105, read only memory (ROM) 1110, random access memory (RAM) 1115, communication ports 1140, controller 1120, and/or memory device 1125, described further below. According to some embodiments, the management computing device 208 may include a plurality of management computing devices.

The management computing device 208 may be operatively coupled with communication appliances 220a, 220b, such as a hub, router, switch, and/or virtual implementations thereof for providing communication with various modules. In an embodiment, the communication appliances 220a, 220b may be associated with a routing manager application configured to manage the routing of data, such as packet routing methods. A communication appliance 220a may be configured to communicate with device agents 225a-225n. In an embodiment, the communication appliance 220a may include multiple communication appliances, with each configured to communicate using one or more communication protocols, one communication appliance configured to communicate using one or more communication protocols, or combinations thereof.

The device agents 225a-225n may include a communication port 245 configured to receive and/or transmit communication signals with the communication appliance 220a. For example, the communication port 245 may include an Ethernet port configured to communicate with the management computing device 208 over a wide area network (WAN), local area network (LAN), and/or the Internet. The management computing device 208 may communicate with device agents 225a-225n located in various physical locations and/or logical locations (for example, located on a separate logical communication network). For instance, the management computing device 208 may be located at a manufacturer facility and the device agents 225a-225n may be separately located in consumer homes. In another instance, the management computing device 208 may be located in a central office of a healthcare provider and the device agents 225a-225n may be separately located in patient rooms.

In an embodiment, each of device agents 225a-225n may include a physical device, such as a computing device having a memory 230 in operative communication with a processor 235. The memory 230 may include program instructions that, when executed by the processor 235, cause a local control program to be executed on the device agent 225a-225n. In another embodiment, the device agents 225a-225n may be implemented in software configured to operate on a device 214. In a further embodiment, the device agents 225a-225n may be configured partially in hardware and partially in software.

Each of the device agents 225a-225n may be configured in a similar manner as described herebelow for device agent 225a. A device agent, such as device agent 225a, may include communication ports 240a-240n configured to facilitate communication with a device 210a-210n. The communication ports 240a-240n may include physical ports, virtual ports (for example, communication ports implemented in software), emulated ports, or combinations thereof. Each device 210a-210n may include a communication port (not shown) for communication with the device agent 225a and the management computing device 208 (as shown in FIG. 1 and not shown in FIG. 2 to avoid obfuscation, each of the devices 210a-210n, may be in communication with the management computing device 215). Device agent 225a may be configured to communicate with devices 210a-210n using various communication protocols, including, without limitation, serial (RS232), Ethernet, cellular data network protocols, universal serial bus (USB), Thunder bolt, radio-frequency identification (RFID), Bluetooth, Zigbee, general purpose input/output (GPIO), near-field communication (NFC), and combinations thereof.

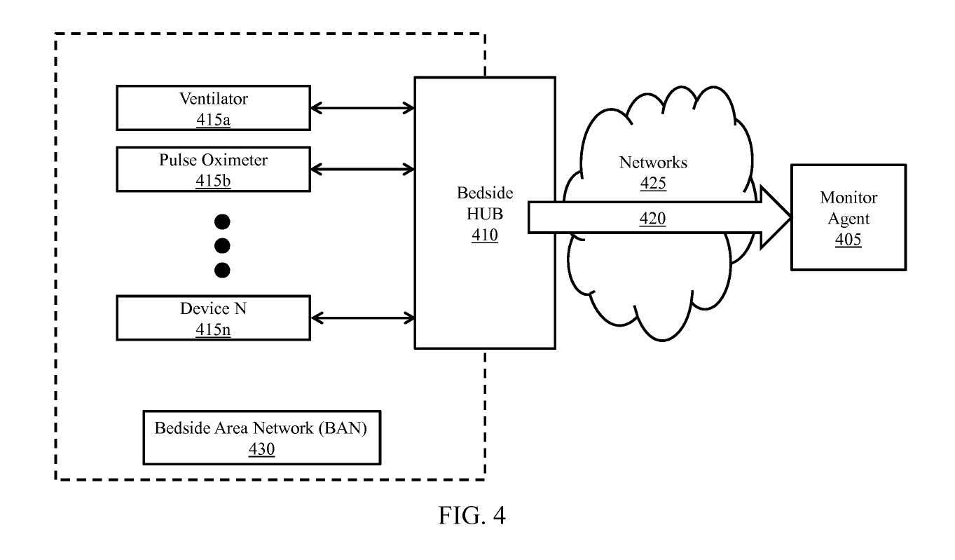

In an embodiment, the device agents 225a-225n and/or the management computing device may be associated with a hub (for example, a physical hub (not shown, see FIGS. 4-9) or a hub implemented in software) configured to collect all of the various types of data and to organize the data into a integrated data stream for its own use and/or for the control system 200.

The management computing device 208 may operate a control application configured to monitor and/or control any of devices 210a-210n, 212a-212n, 214. Each device agent 225a-225n may execute a local version of the control application to monitor and/or control a device 210a-210n, 212a-212n, 214 operatively coupled thereto. In an embodiment, devices 210a-210n and 212a-212n may include devices operatively coupled to a device agent 225a-225n device (for example, a computing device) and device 214 may execute a device agent 225n implemented in software. The control application may include various program modules for carrying out aspects of some embodiments described herein. For instance, the control application may include program modules for communicating with a device 210a-210n, 212a-212n, 214, such as program modules for facilitating the exchange of data and/or control signals using the communication protocols of the device.

During operation, a device 210a-210n, 212a-212n, 214 may generate device information, and the control application may include program modules for receiving the device information. The type and the nature of the device information may depend on the type of device 210a-210n, 212a-212n, 214 and any elements, sensors, and the like configured to generate the device information for the device. For example, any of devices 210a-210n, 212a-212n, 214 may include a global positioning system (GPS) element configured to provide positioning information for the device 210a-210n, 212a-212n, 214. In another example, any of devices 210a-210n, 212a-212n, 214 may include a blood pressure element configured to provide blood pressure information for the user of the device. As such, the control application may be configured to receive, store, manipulate, or otherwise use the type and format of the device information.

The management computing device 208 and/or the device agents 225a-225n may be configured to receive device information through a data streaming process. In this manner, the device information may be transmitted in real-time or substantially real-time. In an embodiment, the control application and/or a data streaming application in operable communication with the control application may manage various aspects of the data streaming process, such as managing latency, quality-of-service (QoS), buffering, jitter, packet loss numbers, round-trip time, or the like. The data streaming process may be configured to manage data streaming in a bi-directional manner, as data may be streamed on various levels, such as from the devices 210a-210n, 212a-212n, 214 to the device agents 225a-225n, from the device agents to the management computing device 208, from the management computing device to client devices 250a, or any combinations thereof.

Data streaming may be implemented using various protocols, including, without limitation, real time streaming protocol (RTSP), transmission control protocol (TCP), and/or hypertext transfer protocol (HTTP) streaming, such as HTTP live streaming, real-time transport protocol RTP. According to some embodiments, the protocol used to implement data streaming may include various components and/or sub-protocols configured to carry out certain aspects of data streaming. For example, the protocol may include a payload sub-protocol configured to manage: (1) a sequence number, which may be used to detect lost packets; (2) a payload identification, which may be configured to describe a specific media encoding so that it may be changed if it has to adapt to a variation in bandwidth; (3) a frame indication, which may be configured to mark the beginning and end of each frame; (4) a source identification, which may identify the originator of the frame; and (5) timestamps, which may be used to detect different delay jitter within a single stream and to compensate for the delay jitter. In another example, the protocol may include control components, such as the following illustrative and non-limiting examples: (1) quality of service (QoS) feedback, which may include the number of lost packets, round-trip time, and/or jitter, such that the sources may adjust their data rates accordingly; (2) session control, which may allow participants to indicate that they are leaving a session; (3) identification, which may include a participant's name, e-mail address, and/or telephone number, for the information of other participants; and (4) inter-media synchronization, which may enable the synchronization of separately transmitted different type of streams.

The control application may include program modules configured to control various aspects of a device 210a-210n, 212a-212n, 214. For instance, the control application may include program modules configured to transmit control signals to a device 210a-210n, 212a-212n, 214 based on the control elements of a device. In an embodiment, the control application may include automated control program modules or protocols for automated control of a device 210a-210n, 212a-212n, 214 based on the device information. In an embodiment, the control application may be configured to receive control instructions from one or more client devices 250a-250n.

According to some embodiments, the control application may generate a device model or protocol for each device 210a-210n, 212a-212n, 214 based on the device information, a pre-determined model, or a combination thereof. The device model may be configured to provide expected operating conditions of a device 210a-210n, 212a-212n, 214. The control application may update the device model based on the device information. For example, the control application may operate to learn the operational characteristics of a device 210a-210n, 212a-212n, 214 for a particular user based on a default device model that is dynamically and automatically updated using the device information. According to some embodiments, the device model may include any type of information, control application, parameters, operating protocol, user profiles, device profiles, or any other type of information or control modules associated with the device 210a-210n, 212a-212n, 214. For example, the data model may include an operating program to control a device 210a-210n, 212a-212n, 214. The data model may be updated based on device information and/or other information stored in the database 115 to control the operation of the device 210a-210n, 212a-212n, 214 based on new information, learned information, or the like.

In an embodiment, the device model may include a rule-based expert system that may be configured to improve, tune, upgrade, or otherwise modify the operation of a device 210a-210n, 212a-212n, 214. For example, the control application may be configured to analyze all of the device information from the devices 210a-210n, 212a-212n, 214, for example, to determine the effectiveness of their operation to make adjustments to the device model (such as operating programs, parameters, operating protocols, or the like) to improve performance (for example, to “learn” how a user interacts with a device based on certain conditions, parameters, or the like) or to achieve other goals. The control application may transmit updated device models (for example, updated local device models) to the device agents 225a-225n so that the device agents may have the improved device models to, for example, operate a device 210a-210n, 212a-212n, 214 based on the improved protocol generated by the control application. For instance, a device model for a ventilator may be updated responsive to the control application determining that certain ventilators operate better with a different parameter configuration. In another example, an operator (for example, through a client device 250a-250n) may institute the change through a user interface (for example, communicated to the management computing device 208 through communication appliance 220b) in substantially real time. In this manner, the operator and/or control application may institute a change in the operating characteristics of a wide range of devices (devices in communication with central management system 205 and/or components thereof, such as the device agents 225a-225n) through a single update transmission.

The local control application operating on a device agent 225a-225n may use the device model to locally operate a device 210a-210n, 212a-212n, 214. In an embodiment, the local control application may be validated, verified, and assessed for repeatability by the control application operating on the management computing device 208. Some embodiments provide that the control application operating on the management computing device 208 may be configured as a main control application and the local control application operating on the device agents 225a-225n may be a backup control application used, for example, if communication is lost between the management computing device and the devices 210a-210n, 212a-212n, 214. In an embodiment, the device model may be generated by the main control application and transmitted to the local control application on an automated and/or operator controlled basis.

The management computing device 208 may be in operative communication with client devices 250a-250n through communication appliance 220b. The client devices 250a-250n may access the device information, including real-time or substantially real-time device information from the management computing device and/or historical device information stored in a device information database 215. In an embodiment, the management computing device 208 may be configured to receive various control instructions from the client computing devices to control aspects of the devices 210a-210n, 212a-212n, 214. For example, an operator may power a device 210a-210n, 212a-212n, 214 on/off, change an operating parameter of a device, stop/start device elements, or the like. The client devices 250a-250b may include various types of computing devices, including servers, personal computers (PCs), and mobile computing devices, such as tablet computing devices, smart phones, or the like. The control application may communicate with the client devices 250a-250n through various interfaces, such as a client application, web-based application, mobile application (“mobile app” or “app”), or combinations thereof.

The configuration of device program modules configured to allow the main control application and the local control application to receive device information and/or to control a device 210a-210n, 212a-212n, 214 may be specific for each device and/or category of devices. For example, particular devices 210a-210n, 212a-212n, 214 may be associated with particular elements configured to generate certain types of device information and/or to control certain aspects of the device, which may be different for each type of device. As described above, the control system 200 may be configured to operate with any type of device capable of generating device information and/or being controlled through the control application configured according to embodiments described herein.

Illustrative and non-limiting examples of devices 210a-210n, 212a-212n, 214 may include medical equipment (for example, ventilators, respirators, automated injection devices, medial imaging equipment, patient vital sign monitor/detectors, such as blood pressure, pulse, and oxygen monitors, continuous positive airway pressure (CPAP) systems, BiLevel or BiPap systems, balloon pump systems, anesthesia systems, intravenous (IV) delivery systems, electronic cardiac systems, respiratory diagnostic alert systems, cardiac diagnostic alert systems, sleep apnea diagnostic and therapeutic systems, remote hospital, operating or home monitoring systems, home wound systems, medical guidance systems, or the like), ambulance or field-based emergency units, industrial equipment (for example, manufacturing devices associated with sensors configured to indicate the status of device components), clothing with embedded sensors (for example, wet suits with sensors for detecting the property of water, garments with sensors for detecting certain characteristics of a wearer, such as heart rate, temperature, or the like), computing devices, emergency systems, alarm systems, camera systems, home appliances, consumer electronics, exercise equipment, and transportation electronics systems (for example, airplane control systems, automotive computer systems, in-car entertainment systems, or the like).

The following non-limiting examples provide illustrative control system applications according to some embodiments. In a first non-limiting example, a device may include a ventilator and a pulse oximeter connected to a patient in their home. A personal computer may be located in the home and configured as a device agent operative to execute a local control application for the ventilator and the pulse oximeter. A healthcare professional may initially configure the local control application by connecting the device agent to a central control system that transfers the ventilator and pulse oximeter control applications to the device agent. The ventilator may have parameters for setting the flow rate and mode, such as an assist/control mode or a pressure support ventilation mode, and may have sensors for detecting inhaled tidal volume, exhaled tidal volume and end expiratory pressure. The local control application may be configured to receive device information from the sensors and to build a device model for the particular patient using the ventilator. During operation of the ventilator, the device agent may receive device information including the inhaled tidal volume, exhaled tidal volume and end expiratory pressure from the ventilator sensors. The local control application may monitor the streamed device information and update the device model based on the latest device information. The device model may provide an operational range for the particular patient using the ventilator. The local control application may modify the flow rate parameters responsive to the device information indicating that the flow rate should be adjusted according to a ventilator control protocol specified in the local control application. The local control application may transmit the device information to the central control system, which may store the device information in a historical database.

A remote operator, such as a healthcare provider, may monitor the operation of the ventilator from a remote location. If there is an issue with the ventilator, such as incorrect or inefficient operation, the operator may adjust the operation of the ventilator through a graphical user interface (GUI). For instance, the operator may make a selection to increase a parameter on the GUI, which will be transmitted through a management computing device to the ventilator (or through a device agent or directly to the device) or to a device controlling the ventilator to adjust the parameter. In this manner, a patient may receive immediate assistance (essentially real-time) without the healthcare facility having to send a healthcare provider to the residence of the patient.

In the first non-limiting example, the device agent may monitor the use of the device's disposables and at an appropriate time indicate the useful life has expired and prompt a remote operator to replace the devices applicable disposable (for example, by automated delivery or upon the next visit to the patient's home). At the same time, the central management system may control the purchase and procurement of an additional disposable.

In a second non-limiting example, a control system may be configured to monitor consumer electronic devices, a camera/motion detecting system, and exercise equipment within a home as part of a health program. A device agent including a mobile app operating on a smartphone and/or tablet computing device may be located in the home. The device agent may be in operable communication with a refrigerator consumer electronic device configured to provide and/or obtain information about the contents of the refrigerator. The device agent may execute a local control application that may receive device information from the refrigerator indicating foods consumed by a user of the refrigerator and may update a device model for each user of the refrigerator. The local control application may calculate various health-based metrics, such as calories consumed, for each user based on the device information from the refrigerator consumer electronic device. The local control application may generate a message (such as an email or text message) alerting a user about certain aspects of the contents of the refrigerator consumer electronic device, such as the need to order a consumed item, place an order through an automated, electronic ordering system for the item, or lock the door.

In this second non-limiting example, the local control application may include a program module for the camera/motion detection device. The program module may operate to receive device information from the camera/motion detection device indicating characteristics of movement of a user, such as during an exercise. The program module may generate a device model for the type and duration of movements of a user during exercise and may calculate certain metrics associated with the movement, such as the number of calories expended by the user. The device agent may also receive device information from a treadmill and a stepper machine exercise equipment, such as the frequency and intensity of use by certain users. The device information from the exercise equipment and the camera/motion detection device may be used as part of the health program, for instance, to calculate the amount of burned calories, user activity, or the like. The device information may be transmitted to a central control system and used as part of a health regimen for the user monitored by a health and fitness organization.

In a third non-limiting example, an article of clothing may have sensors embedded therein. The article of clothing may be configured as an armored protective garment configured to be worn on the torso of a user. The sensors may include a temperature sensor, a heart rate sensor, and a sensor that detects whether a portion of the garment has been penetrated. The garment may include a wireless transceiver configured to communicate wirelessly with a device agent computing device that is connected via a satellite link to a central control system. During use by the wearer, data from the temperature and heart rate sensors may be transmitted to the device agent and from the device agent to the central control system. A device model for the wearer may be maintained and a baseline temperature and heart rate for the user in certain situations (for example, stressful versus non-stressful situations) may be established. The device information may include information that the garment has been penetrated responsive to the garment being pierced by an object, including a zone of the penetration on the garment (for example, stomach area, chest area, or the like). The device information may be observed through a graphical user interface, as well as the temperature and heart rate data of the user, at the central control system and a medical team may be dispatched based on the device information while a local agent may be deployed to activate a local tourniquet in the zone of penetration.

Healthcare providers and other caregivers often determine control strategies for a single device by gathering information from multiple devices and then, based upon personal assessments, may adjust the control of a single device. In a fourth non-limiting example, an individual may view the respiratory parameters and patient data from a ventilator user interface, then they may view the information regarding cardiac status on the echocardiogram (ECG) monitor, and they may view the status of oxygenation from an oximeter at the bed or gather information from a laboratory. Based upon the synthesis of this information, such as through the application of a set of rules or physician orders, the caregiver may then adjust the control of oxygen delivery to the patient. In this manner, the control application may gather information rapidly from many other devices and sources and then rapidly employ a control change to therapy. This response time to react may be in substantially real-time, improving the response to provide dynamic care or information, particularly compared to the manual effort of collecting synthesizing and controlling the devices manually. In addition, the control application may apply such changes to other devices (for example, ventilators) within the network.

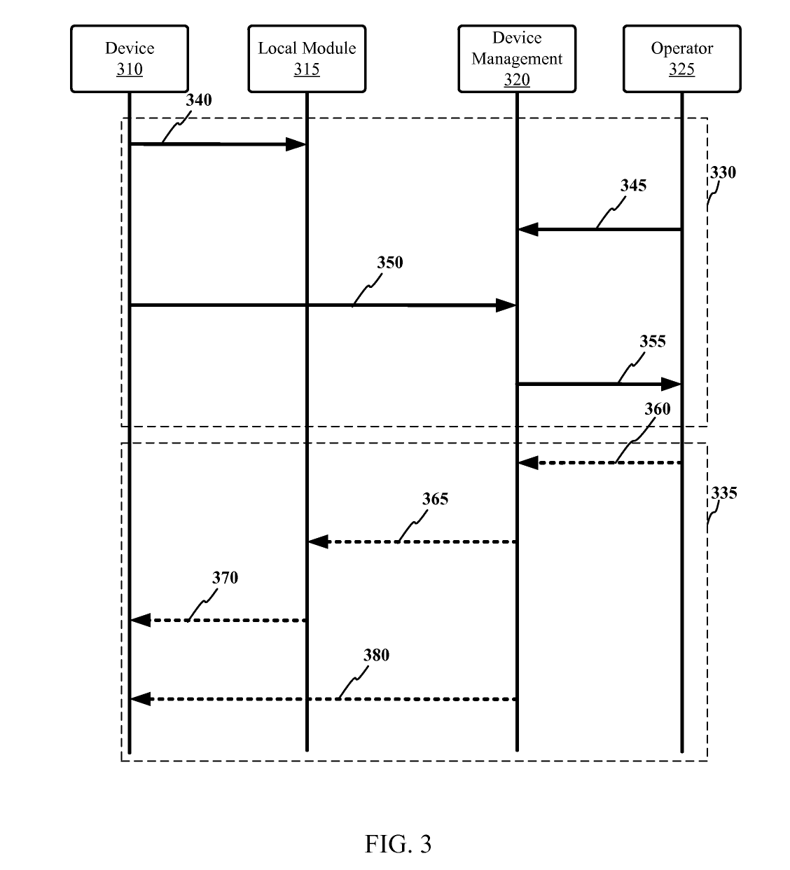

FIG. 3 depicts illustrative information and control signal flow according to some embodiments. As shown in FIG. 3, a device 310, a device agent 315, a central control 320, and an operator 325 may be in operable communication through data signals 330 and control signals 335. Device information may be transmitted from a device 310 to the device agent 315 through signal 340 and from the device to the central control 320 through signal 350. The central control 320 may transmit device information to an operator 325 through signal 355 and the operator 325 may send information, such as information associated with device settings, to the central control 320 through signal 345.

The device agent 315 may transmit control information to the device 310 through signal 370. The central control 320 may transmit control information to the device agent 315 through signal 365. The control information transmitted 365 to the device agent 315 may be used locally at the device agent, may be transmitted to the device 310 through signal 370, or a combination thereof. The central control 320 may send control information directly to the device 310 through signal 380. An operator 325 may send a control signal to the central control 320 through signal 360. The central control 320 may transmit the operator 325 control signal to the device agent 315 through signal 365 or to the device 310 through signal 380.

FIGS. 4-9 depict illustrative flow diagrams for an acute care ventilation monitoring and control system according to an embodiment. FIG. 4 depicts a first device information flow diagram for the acute care ventilation monitoring and control system according to an embodiment. As shown in FIG. 4, ventilation devices 415a-415n may be arranged in a bedside area network (BAN) 430 in operable communication with certain networks 425, such as a corporate or hospital network, through a bedside hub 410. The bedside hub 410 may operate to transmit information 420, such as device information acquired from the ventilation devices 415a-415n to a monitor agent 405 and to store some or all of the data acquired from the ventilation devices 415a-415n in a backup storage. In an embodiment, the bedside hub 410 may be configured as a hub for data associated with the BAN 430, collecting clinical data, including, without limitation, ambient sound, surveillance video, monitor screens, images, device settings, measured patient values, and alarm conditions from the heterogeneous devices 415a-415n which are associated with a particular patient. The ventilation monitoring and control system may be configured to handle clinical data in various formats, such as binary formats including, without limitation, moving picture experts group (MPEG), such as MPEG-4 Part 14 (MP4), MPEG-1 and/or MPEG-2 (MP3), waveform audio (WAV), audio video interleave (AVI), joint photographic experts group (JPG or JPEG), portable network graphics (PNG), extensible markup language (XML), hypertext markup language (HTML), American Standard Code for Information Interchange (ASCII), or the like. The bedside hub 410 may be configured to multiplex, interleave or concatenate device information acquired from multiple devices, combining the data into a single, synchronous transmission bit-stream.

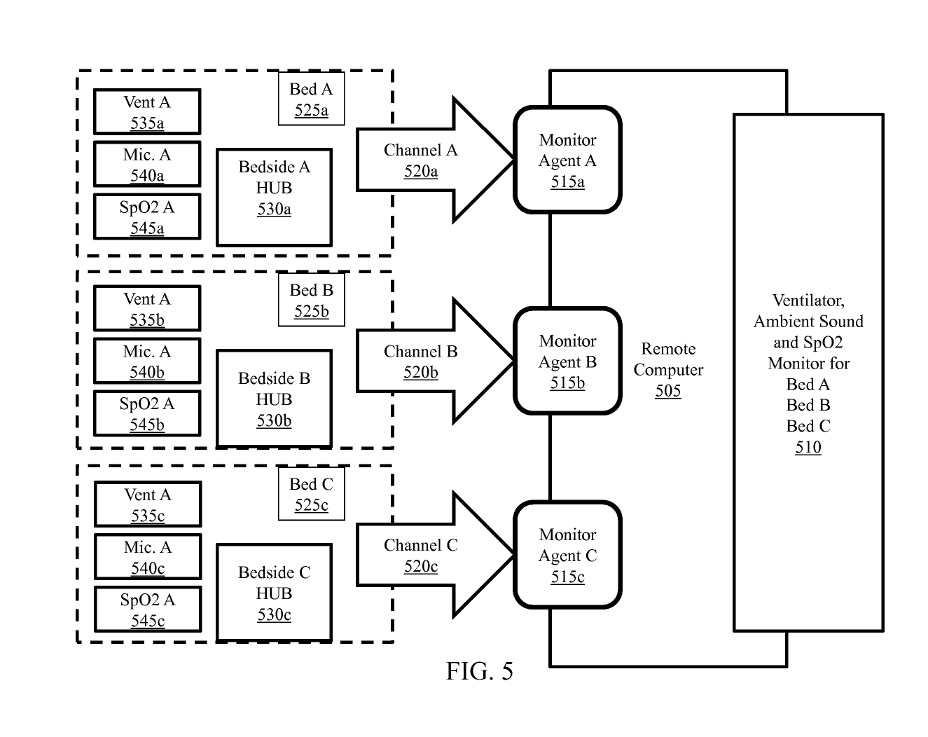

FIG. 5 depicts a second device information flow diagram for the acute care ventilation monitoring and control system according to an embodiment. As shown in FIG. 5, a plurality of BANs 525a-525c, each including a bedside hub 530a-530c and various devices, such as a ventilator 535a-535c, a microphone 540a-540c and a pulse monitor 545a-545c, are depicted. Each bedside hub 530a-530c may operate to transmit device information over a dedicated channel 520a-520c to a corresponding monitoring agent 515a-515c (for example, a device agent) associated with a remote computer 505. The remote computer 505 may include a monitor 510 for the various devices associated with each BAN 525a-525c.

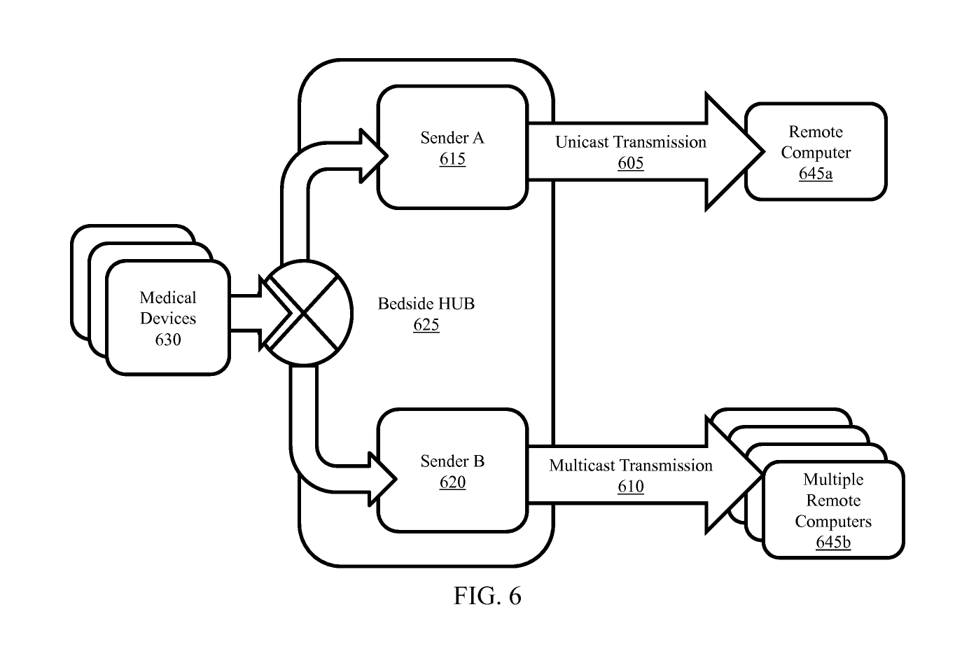

FIG. 6 depicts an illustrative data transmission flow diagram for the acute care ventilation monitoring and control system according to an embodiment. As shown in FIG. 6, medical devices 630 may be in operative connection with a bedside hub 625 associated with data senders 615, 620. According to some embodiments, data transmission within the acute care ventilation monitoring and control system may be implemented, at least partially, through bit-stream based communication. A bit-stream may include sender (for example, data senders 615, 620) and receiver (for example, remote computers 645a, 645b) components. The sender may transmit continuous data over unicast or multicast network services. The receiver may monitor the delivery of data and detect QoS issues, such as packet loss, and may compensate as necessary. According to some embodiments, prior to actual data transportation, a header packet may be sent from the sender to inform the receivers of the characteristics of the coming bit-stream and to instruct the receivers on how to reconstruct the data. As shown in FIG. 6, sender A 615 transmits a bit-stream over a unicast transmission 605 to a remote computer 645a, while sender B 620 transmits a bit stream over a multicast transmission 610 to multiple remote computers 645b.

A bit-stream based system may be configured to operate on any packet-based network, such as TCP/IP. The data stream may be divided and packed into multiple packets, with each packet being numbered sequentially with encoding information. A receiver may send QoS feedback, such as numbers of lost packets, round-trip time, jitter to the sender, or the like. The sender may adjust communication parameters, such as transmission data rates, accordingly. Intra-media synchronization mechanisms may be applied to compensate for potential play-out discontinuity, for instance, from network delay variation (jitter) between separately transmitted bit-streams.

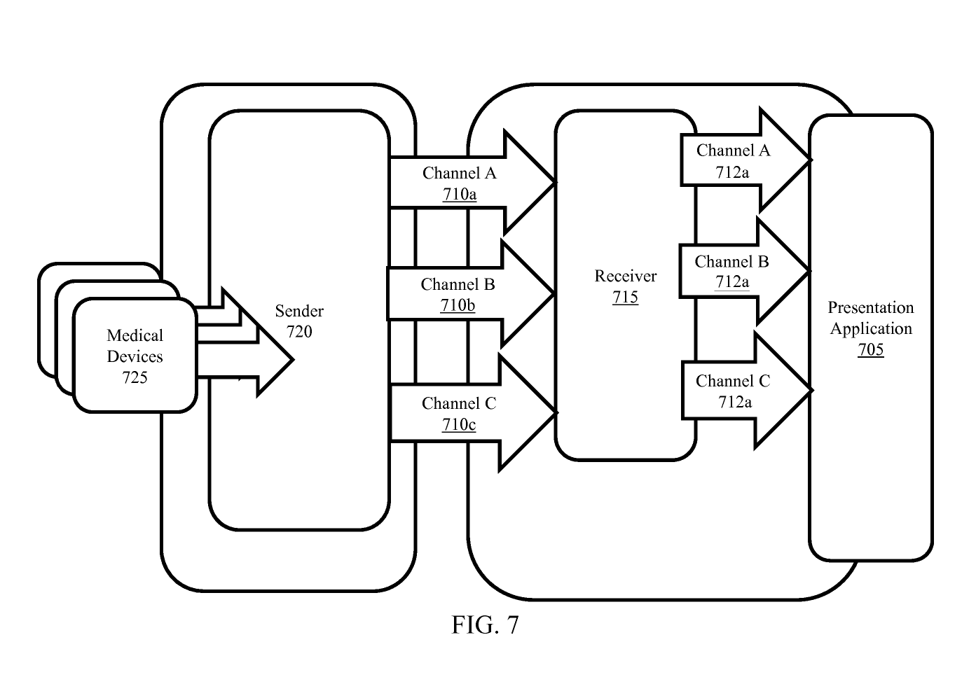

FIG. 7 depicts an illustrative data presentation flow diagram for the acute care ventilation monitoring and control system according to an embodiment. As shown in FIG. 7, medical devices 725 may transmit device information to a sender 720 which transmits bit-streams over channels 710a-710c for each BAN to a receiver 715, such as a remote computer. The receiver 715 may transmit the device information through communication channels 712a-712c to a presentation application 705. For example, the presentation application may include a web-based application available through a network (such as networks 425 or the Internet) or a client application accessible through a client computing device.

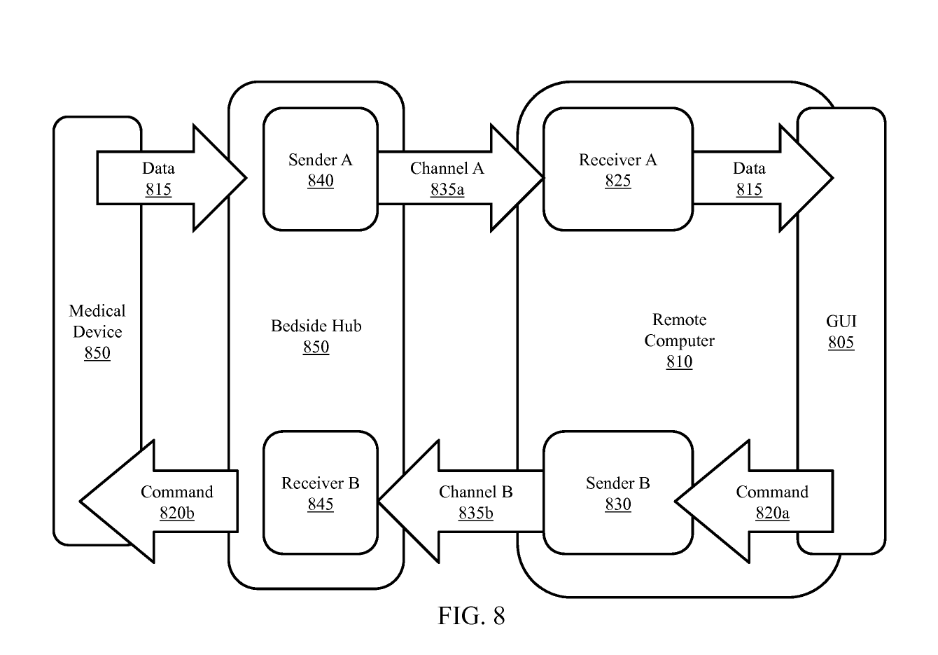

FIG. 8 depicts a first illustrative data and control information flow diagram for the acute care ventilation monitoring and control system according to an embodiment. As shown in FIG. 8, a medical device 855 may transmit data 815 to bedside hub 850. A sender A 840 may be configured to bit-stream the device information through channel A 835 to a receiver 825. The receiver 825 may transmit the device information 815 to a graphical user interface (GUI) 805 accessible by an operator. The operator may initiate a command 820 from the GUI, which is transmitted to sender B 830. The command 820 may be transmitted to receiver B 845 from sender B 830 through channel B 860. Receiver B 845 of the bedside hub 850 may transmit the command 820 for execution at the medical device 855.

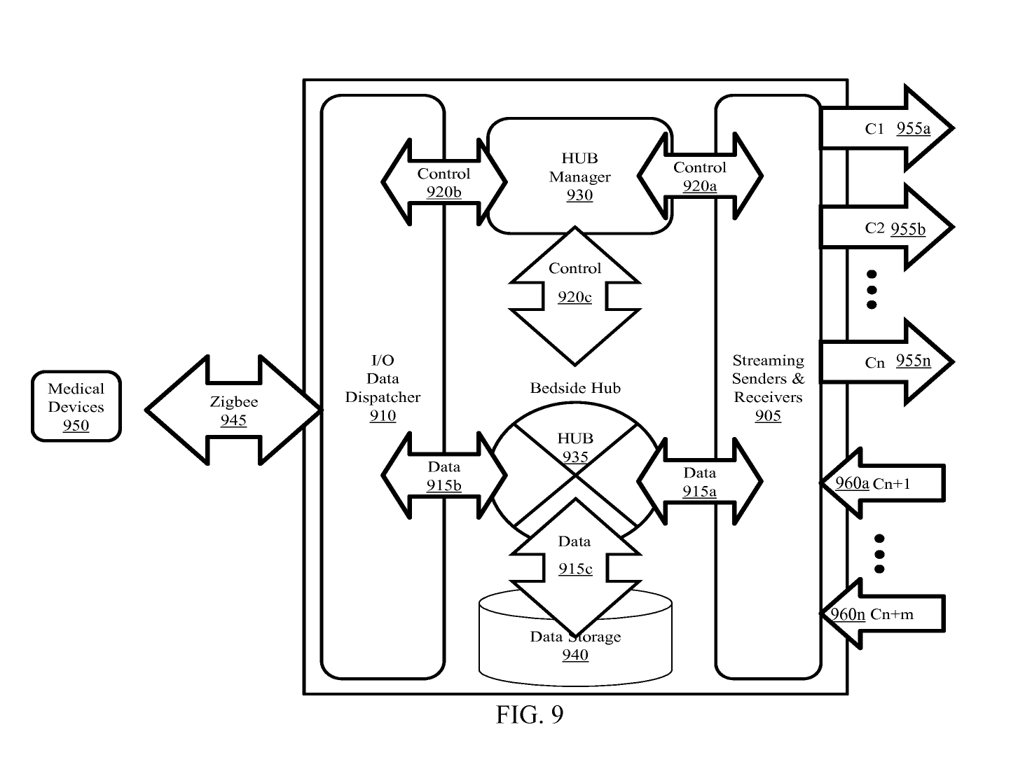

FIG. 9 depicts a second illustrative data and control information flow diagram for the acute care ventilation monitoring and control system according to an embodiment. As shown in FIG. 9, a medical device 950 may have a communication link 945 with an I/O data dispatcher 910 operative on a hub 935. The I/O data dispatcher 910 may be configured to receive control information 920 and data 915 from a hub manager 930 and a hub 965, respectively. In an embodiment, the I/O data dispatcher 910 may transmit requests to and receive data from the medical device 950. The hub manager 930 may receive control information 920 and the hub may receive data 915 from streaming senders and receivers 905. The streaming senders and receivers 905 may transmit information through transmission channels 955a-955n and may receive information through receiver channels 960a-960n.

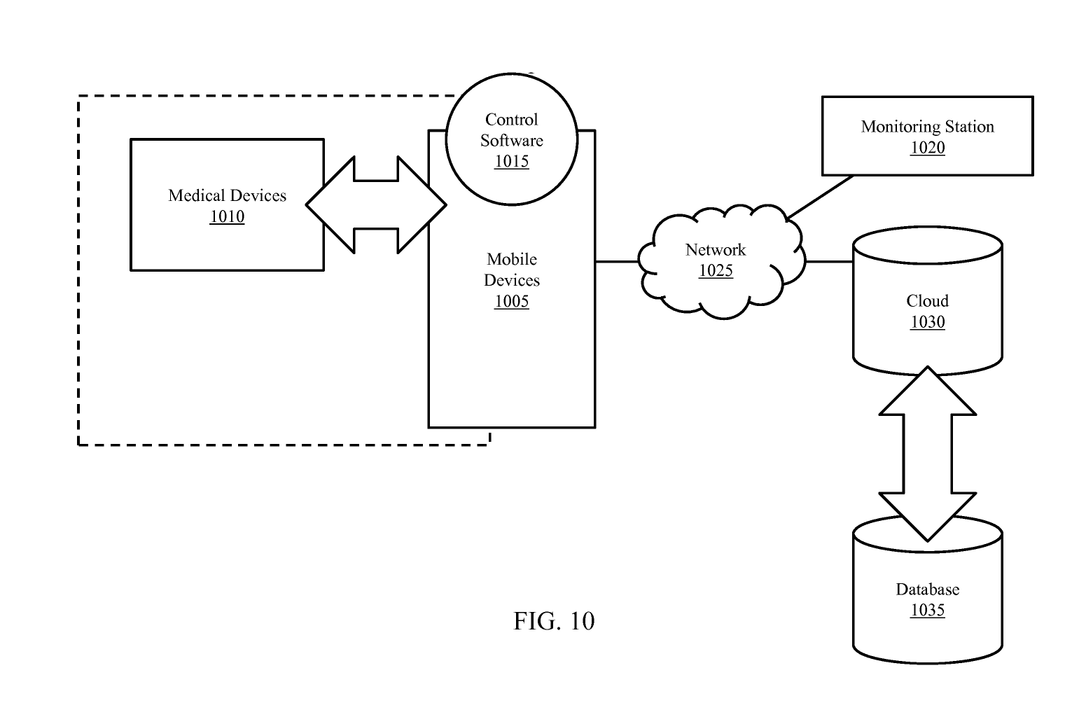

FIG. 10 depicts an illustrative control system network according to an embodiment. As shown in FIG. 10, medical devices 1010 may be operatively coupled with a mobile device 1005 configured to execute control software 1015 configured according to embodiments described herein. The mobile device 1005 may be connected to a network, such as a WAN, a LAN, or the Internet. A monitoring station 1020, such as a healthcare facility located, for example, in another country (for example, a foreign medical office contracted to analyze medical information from the medical devices 1010) may be connected to the network 1025 and may be capable of receiving information from the medical devices and/or controlling various aspects thereof. Device information associated with the medical devices 1010 may be transmitted through the network 1025 and to a cloud 1030 or other web-based data storage and/or service application system. The cloud 1030 may be configured to exchange data with one or more databases 1035, such as a picture archiving and communication system (PACS), health information networks (HINs), or the like.

FIG. 11 depicts a block diagram of exemplary internal hardware that may be used to contain or implement program instructions according to an embodiment. A bus 1100 serves as the main information highway interconnecting the other illustrated components of the hardware. CPU 1105 is the central processing unit of the system, performing calculations and logic operations required to execute a program. CPU 1105, alone or in conjunction with one or more of the other elements disclosed in FIGS. 1 and 6, is an exemplary processing device, computing device or processor as such terms are using in this disclosure. Read only memory (ROM) 1110 and random access memory (RAM) 1115 constitute exemplary memory devices.

A controller 1120 interfaces with one or more optional memory devices 1125 to the system bus 1100. These memory devices 1125 may include, for example, an external or internal DVD drive, a CD ROM drive, a hard drive, flash memory, a USB drive or the like. As indicated previously, these various drives and controllers are optional devices.

Program instructions, software or interactive modules for providing the digital marketplace and performing analysis on any received feedback may be stored in the ROM 1110 and/or the RAM 1115. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 1130 may permit information from the bus 1100 to be displayed on the display 1135 in audio, visual, graphic or alphanumeric format. Communication with external devices may occur using various communication ports 1140. An exemplary communication port 1140 may be attached to a communications network, such as the Internet or an intranet. Other exemplary communication ports 1140 may comprise a serial port, a RS-232 port, and a RS-485 port.

The hardware may also include an interface 1145 which allows for receipt of data from input devices such as a keyboard 1150 or other input device 1155 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A device management system comprising:
at least one management computing device comprising:
a processor, and
a non-transitory, computer-readable storage medium in operable communication with the processor, wherein the computer-readable storage medium contains one or more programming instructions that, when executed, cause the processor to:
receive device information from at least one device,
update a device model associated with the at least one device based on the device information, and
update a local device model associated with the at least one device stored on at least one device agent operatively coupled to the at least one device, the at least one device agent being configured to receive device information from the at least one device and to monitor the device information based on the local device model.

2. The system of claim 1, wherein the at least one device agent receives the device information through a substantially real-time data stream.

3. The system of claim 1, wherein the at least one device comprises a plurality of heterogeneous devices.

4. The system of claim 1, wherein the at least one device comprises at least one of the following: a medical device, a sensor, a consumer electronic device, a microphone, and a video camera.

5. The system of claim 1, wherein the at least one device agent is operatively coupled to the at least one device through at least one of the following: serial, Ethernet, cellular data network protocols, universal serial bus, Thunder bolt, radio-frequency identification, Bluetooth, Zigbee, general purpose input/output, and near-field communication.

6. The system of claim 1, wherein the at least one device agent is further configured to control the at least one device.

7. The system of claim 1, wherein the one or more programming instructions, when executed, cause the processor to present the device information to at least one client device.

8. The system of claim 1, wherein the one or more programming instructions, when executed, cause the processor to receive commands for controlling the at least one device from at least one client device.

9. The system of claim 1, wherein the at least one device agent comprises at least one of the following: a personal computer, a tablet computing device, a smart phone, and a server.

10. The system of claim 1, wherein the at least one management computing device is operatively coupled with the at least one device agent through at least one of the following: Ethernet, WiMax, cellular data network protocols, real-time transport protocol, real-time transport control protocol, and transport control protocol/Internet protocol.

11. A method of managing at least one device, the method comprising:
providing at least one management computing device;
receiving, by a processor of the at least one management computing device, device information from at least one device;
updating, by the processor, a local device model associated with the at least one device stored on at least one device agent operatively coupled to the at least one device based on the device information, the at least one device agent being configured to receive device information from the at least one device and to monitor the device information based on the local device model.

12. The method of claim 11, wherein the at least one device agent receives the device information through a substantially real-time data stream.

13. The method of claim 11, wherein the at least one device comprises at least two heterogeneous devices.

14. The method of claim 11, wherein the at least one device comprises at least one of the following: a medical device, a sensor, a consumer electronic device, a microphone, and a video camera.

15. The method of claim 11, wherein the at least one device agent is operatively coupled to the at least one device through at least one of the following: serial, Ethernet, cellular data network protocols, universal serial bus, Thunder bolt, radio-frequency identification, Bluetooth, Zigbee, general purpose input/output, and near-field communication.

16. The method of claim 11, wherein the at least one device agent is further configured to control the at least one device.

17. The method of claim 11, further comprising presenting the device information to at least one client device.

18. The method of claim 11, further comprising receiving commands for controlling the at least one device from at least one client device.

19. The method of claim 11, wherein the at least one device agent comprises at least one of the following: a personal computer, a tablet computing device, a smart phone, and a server.

20. The method of claim 11, wherein the at least one management computing device is operatively coupled with the at least one device agent through at least one of the following: Ethernet, WiMax, cellular data network protocols, real-time transport protocol, real-time transport control protocol, and transport control protocol/Internet protocol.

21. A device management system comprising:
at least one device agent operatively coupled to at least one device, the at least one device agent being configured to:
receive device information from the at least one device;
monitor the device information based on a local device model associated with the at least one device; and
receive a local device model update from at least one management computing device operatively coupled to the at least one device agent, the at least one management computing device being configured to receive device information from the at least one device and to generate the local device model update based on the device information.

22. The system of claim 21, wherein the at least one device agent receives the device information through a substantially real-time data stream.

23. The system of claim 21, wherein the at least one device agent is further configured to control the at least one device.

24. The system of claim 21, wherein the one or more programming instructions, when executed, cause the processor to present the device information to at least one client device.

25. The system of claim 21, wherein the one or more programming instructions, when executed, cause the processor to receive commands for controlling the at least one device from at least one client device.
